(19) United States
(12) Patent Application Publication
(10) Pub. No.: US 2020/0139876 A1
(43) Pub. Date: May 7, 2020

(54) Convertible Tension Assembly

(71) Applicant: USA Products Group, Inc., Lodi, CA (US)

(72) Inventor: Manuel Lopez, Lodi, CA (US)

(73) Assignee: USA Products Group, Inc., Lodi, CA (US)

(21) Appl. No.: 16/180,058

(22) Filed: Nov. 5, 2018

(51) Int. Cl. B60P 7/08

(52) U.S. Cl. CPC B60P 7/0876; B60P 7/083

(57) ABSTRACT

A convertible tension assembly that converts from tie down tension assembly to a tarp grip tension assembly having, among other things, a rotatable device configured and positioned for conversion of the assembly, is disclosed herein.

### BACKGROUND

The present disclosure relates generally to a tension assembly, and more particularly to a convertible tension assembly that converts from a tie down tension assembly to a tarp grip tension assembly having, among other things, a rotatable device configured and positioned for conversion of the tension assembly resulting in an efficient, versatile, and simple to use convertible tension assembly to secure an object.

Tension assemblies used to secure cargo or various items are of various configurations including, among others, a cam buckle/ratching style technologies, or relatively simpler means such as tethered clips or elastic type bungee cords. A typical ratchet assembly includes a rotatable hub with a plurality of outwardly-extending teeth for engagement with a spring-loaded pawl. A terminal end of the ratchet assembly is anchored to a first point. As the spool is rotated in one direction, a line, such as a flat webbing attached to a second point is wrapped around the hub to apply a tension to the line. As the hub rotates, the pawl engages the teeth to prevent the hub from rotating in the opposite direction due to the tension from the line.

Cam buckle assembly technology differs in that the cam buckle is depressed to open the teeth of the assembly while manual tension in applied to pull the webbing through the cam buckle. The webbing is typically held in place by a back pressure on the closed teeth of the cam buckle.

Relatively simpler tension assemblies include, among others, a clip that grasps or clamps onto a surface and includes a tethered line that is pulled to apply tension. In a very basic form, a rope or a bungee cord may be attached to the device and tied about an object or attached to a point to apply tension and secure an object.

Although tension assemblies are well known, tension assemblies are limited in versatility by having a single attachment means that prohibits different types of loads from being secured. As such, it would be desirable to provide an improved tension assembly having, among other things, a rotatable device configured and positioned for conversion of the tension assembly from a tie down tension assembly to a tarp grip tension assembly resulting in an efficient, versatile, and simple to use convertible tension assembly to secure an object.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a convertible tension assembly comprises a rotatable device configured to rotate from an extended position to a retracted position, wherein the convertible tension assembly converts to a tie down tension assembly with the rotatable device extended, and the convertible tension assembly converts to a tarp grip tension assembly with the rotatable device in the retracted position.

In other embodiment, convertible tension assembly comprises a body having a first side and a second side spaced apart from each and joined together at a first end and a second end opposite the first end; and a rotatable device configured to rotate from an extended position to a retracted position, wherein the rotatable device is positioned at the first end and includes a first device end and a second device end; wherein the first device end includes an attachment device configured to attach to an anchor point, the attachment device extending from the body in the extended position, and the second device end includes a gripping surface and a slot formed in the first end of the body between the first side and the second side, and wherein the slot is configured to accept a tarp, and in the retracted position the gripping surface and slot retain the tarp.

In another embodiment, a method of converting a tension assembly comprises rotating a rotatable device of the convertible tension assembly from an extended position to a retracted position, wherein the rotatable device includes an attachment device configured to extending from the tension assembly and attach to an anchor point to convert the tension assembly to a tie down tension assembly, and wherein the rotatable device includes a gripping surface, the tension assembly includes a slot configured to accept a tarp, and the slot and gripping surface retain the tarp to convert the tension assembly to a tarp grip tension assembly in the retracted position.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1 shows a perspective view of a convertible tension assembly in accordance with one embodiment disclosed herein.

FIG. 2 shows a perspective view of a second end of the convertible tension assembly shown in FIG. 1 in accordance with one embodiment disclosed herein.

FIG. 3 shows an expanded view of the convertible tension assembly of FIG. 1 in accordance with one embodiment disclosed herein.

FIG. 4A shows a top view of the convertible tension assembly of FIG. 1 in accordance with one embodiment disclosed herein.

FIG. 4B shows a bottom view of the convertible tension assembly of FIG. 1 in accordance with one embodiment disclosed herein.

FIGS. 5A-5C show a rotatable device of the convertible tension assembly of FIG. 1 rotating from an extended position to a retracted position to convert the tension assembly from a tie down tension assembly to a tarp grip tense assembly in accordance with one embodiment disclosed herein.

### DETAILED DESCRIPTION

Exemplary embodiments will now be described with references to the accompanying figures, wherein like reference numbers refer to like elements throughout. The terminology used in the description presented herein is not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a tension assembly, and more particularly to a convertible tension assembly that converts from a tie down tension assembly to a tarp grip tension assembly having, among other things, a rotatable device configured and positioned for conversion of the tension assembly resulting in an efficient, versatile, and simple to use convertible tension assembly to secure an object.

As used herein, the term “hub” is intended to include a spindle, a spool, a sheave, or a similar type article(s) that is configured or may be adapted to permit rotation of the hub to facilitate tensioning of a “line” used for the purpose of applying tension to secure an “object”.

As used herein, the term “line” is intended to include a strap, a rope (round synthetic, natural fiber, metal), a cable, a cord, a flat line (webbing), an anchor line or tensioning line, or a similar type of article(s) that may be adapted to be used with the convertible tension assembly disclosed herein for the purpose of applying tension to secure an “object”.

As used herein, the term “object” is intended to include any load or cargo that are generally secured to prevent movement of the objects(s) while in a static position, or while being moved or transport from one position to another position.

As used herein the term “tarp” is used to include any cloth, material, fabric, or similar item or items that are generally used as a covering or a protective device.

The convertible tension assembly described herein converts from a tie down tension assembly to a tarp grip tension assembly having, among other things, a rotatable device configured and positioned for conversion of the tension assembly resulting in an efficient, versatile, and simple to use conversion tension assembly to secure an object.

Various parts, elements, components, etc., of the tension assembly disclosed herein may be constructed from metal, plastic, composite, or other suitable material or combination thereof for providing a rigid and sturdy structure to facilitate tensioning of a line for the purpose of securing a load.

The actual size and dimension of any and all of the various parts, elements, components, etc., may vary depending on various factors including, among other things, intending application or usage of the tension assembly, as well as the size of the load to be secured or prevented from moving while in a static position, or while being moved or transport from one position to another position.

Connection(s) between the various parts, elements, components, etc., of the tension assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

Although tension assemblies are well known, the known tension assemblies are limited in versatility by having a single attachment means that prohibits different types of loads from being secured. As disclosed herein, it is desirable to provide an improved tension assembly having, among other things, a rotatable device for conversion of the tension assembly from a tie down tension assembly to a tarp grip tension assembly resulting in an efficient, versatile, and simple to use convertible tension assembly to secure an object.

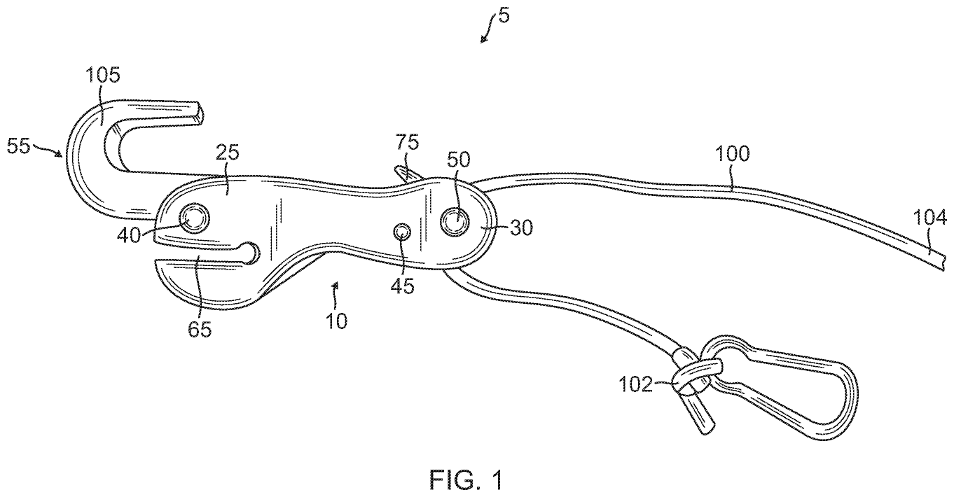

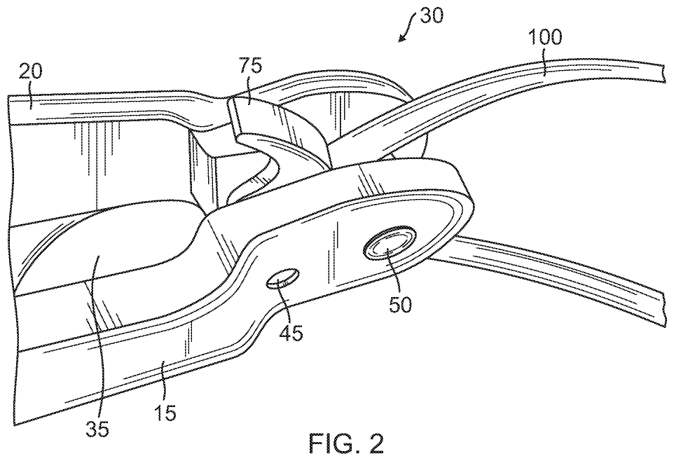

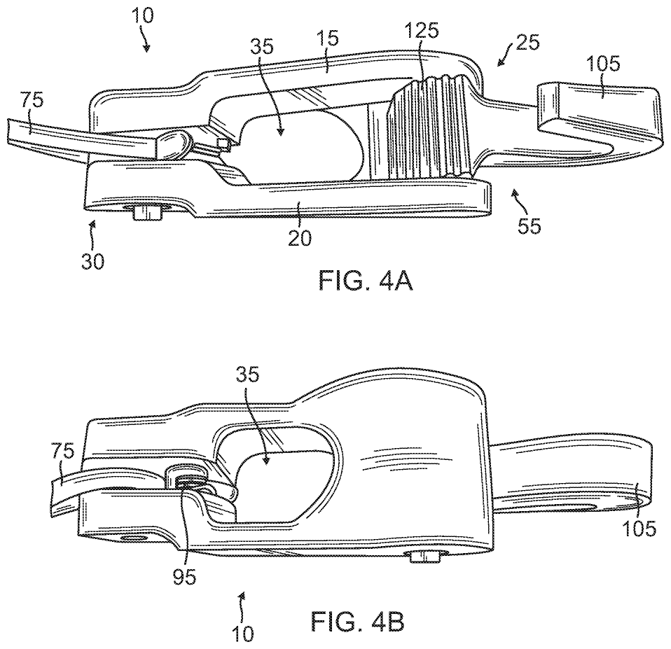

FIG. 1 show a convertible tension assembly in accordance with one embodiment disclosed herein. As shown in FIGS. 1, 4A and 4B, in one embodiment, the convertible tension assembly 5 includes a body 10 having a first side 15 and a second side 20. The first side 15 and the second side 20 are spaced apart and connected to each other at a first end 25 and at a second end 30. The first end 25 is opposite the second end 30. As further shown in FIGS. 4A and 4B, a cavity 35, opening, or pass-through is formed in the body 10 between the first side 15 and the second side 20 of the convertible tension assembly 5. The first side 15 and the second side 20 each include a corresponding first orifice 40, second orifice 45, and third orifice 50 formed therein to accept various parts described herein including hardware to connect the first side 15 to the second side 20.

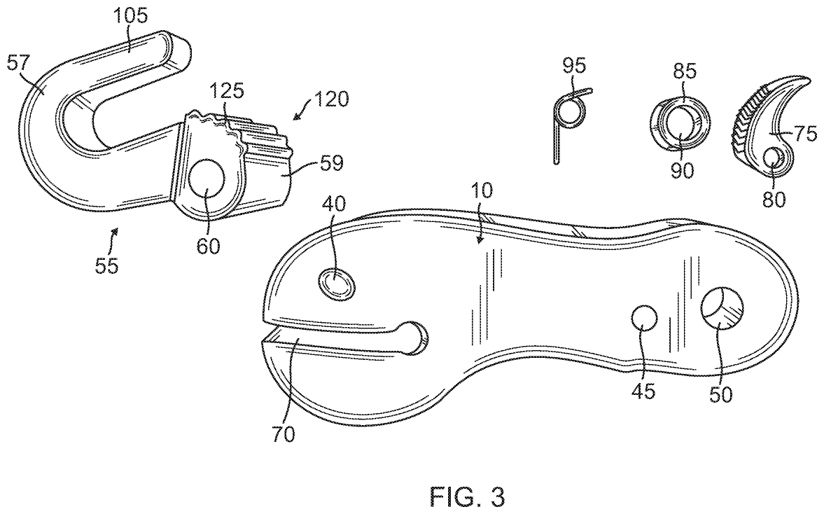

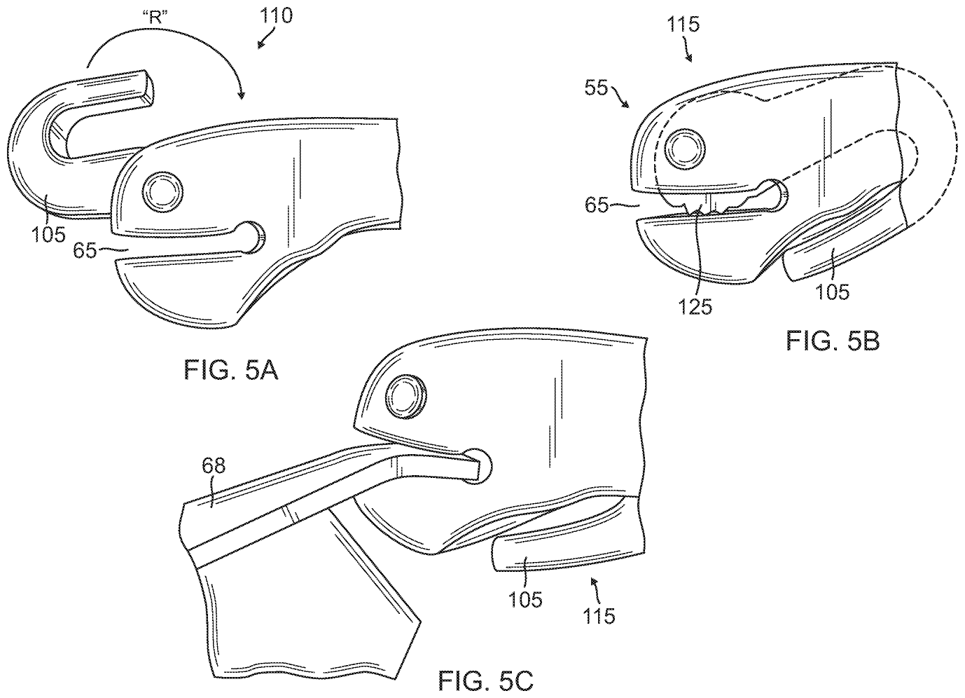

The first end 25 includes a rotatable device 55 having a first opening 60 (FIG. 3). The rotatable device 55 is positioned between the first side 15 and the second side 20 to align the first opening 60 with the first orifices 40 to connect the rotatable device 55 with the first side 15 and the second side 20. The first end 25 of the body 10 further includes an elongated slot 65 having a platform 70 or relatively flat surface (FIG. 3) formed on a lower portion of the slot 65. The slot 65 and the platform 70 extend into the body 10 and are formed between the first side 15 and the second side 20. The elongated slot 65 is configured to accept a tarp 68, cloth, fabric, or other material (FIG. 5C) within the elongated slot 65 and along the platform 70.

Near the second end 30, the body 10 includes a cam 75 having a second opening 80 formed therein. The cam 75 is positioned between the first side 15 and the second side 20 to align the second opening 80 with the second orifices 45 and connect the cam 75 with the first side 15 and the second side 20. The second end 30 further includes a spacer 85 (FIG. 5) having a third opening 90. The spacer 85 is positioned between the first side 15 and the second side 20 to align the third opening 90 with the third orifices 50 and connect the spacer 85 with the first side 15 and the second side 20. A spring 95 is attached and positioned between the first side 15 and the second side 20 to contact the cam 75 and bias the cam 75 against the spacer 85. A line 100, strap, rope, cord, or other similar item is positioned between the cam 75 and spacer 85, and is movable between the first side 25 and second side 30 of the body 10. The line 100 is held in place between the cam 75 and the spacer 85 by the bias on the cam 75. The line 100 is movable between the cam 75 and the spacer 85 when a tension, force, or pressure is applied to the line 100 to overcome the bias placed on the cam 75. The line 100 is also movable when a force or a pressure is applied to the cam 75 to overcome the bias placed on the cam 75 by the spring 95.

As shown in FIG. 5A, the rotatable device 55 is configured to rotate and includes an attachment device such as a hook 105 positioned at a first device end 57 of the rotatable device 55. As shown by reference “R” in FIG. 5A the rotatable device 55 is rotatable from an extended position 110 (FIG. 5A) to a retracted position 115 (FIGS. 5B and 5C). In the extended position 110 the hook 105 extends from the body 10 of the convertible tension assembly 5 and may be attached to any suitable object, load, or anchor point to secure the first end 25 of the body 10. In a similar manner, the line 100 positioned at the second end 30 of the body 10 includes a first line end 102 that may be attached to any suitable object, load, or anchor point to secure the second end 30 of the body 10. The line 100 further includes a second line end 104. As a tension is applied to the second line end 104 to overcome the bias placed on the cam 75 a tension is applied to the convertible tension assembly 5 and to the objects attached to the hook 105 and the first line end 102 of the line 100. Upon release of the tension on the second line end 104 the line 100 is held in place by the cam 75 to maintain tension on the convertible tension assembly 5, the object attached to the hook 105, and the object attached to the first line end 102. In this manner, the convertible tension assembly 5 functions as a tie down tension assembly. A force or pressure applied to the cam 75 to overcome the bias of the spring 95 allows the line 100 to move freely between the cam 75 and spacer 85 thereby removing the tension from the convertible tension assembly 5, the object attached to the hook 105, and the object attached to the first line end 102.

A notable feature of the convertible tension assembly 5 is the rotatable device 55 that it is positioned and configured to convert the convertible tension assembly 5 from a tie down tension assembly to a tarp grip tension assembly. Conversion of the convertible tension assembly 5 takes places when the rotatable device 55 is rotated from the extended position 110 to the retracted position 115 (FIG. 5B and 5C). In the retracted positioned 115 the hook 105 is disposed or tucked away within the cavity 35 of the body 10 formed between the first side 15 and the second side 20. The rotatable device 55 is configured to further include a gripping surface 120 (FIG. 3) formed about the first opening 60 at a second device end 59 of the rotatable device 55 that is opposite the first device end 57. The gripping surface 120 is generally curved and includes for example ribs 125 formed on the gripping surface 120. In this regard, as shown in the progression from FIGS. 5A-5C, as the rotatable device 55 is rotated from the extended position 110 to the retracted position 115 the ribs 125 formed on the gripping surface 120 are exposed in the slot 65 and contact the tarp 68 or other material positioned within the slot 65 and along the platform 70 formed in the first end 25. Due to the generally curved shaped of the gripping surface 120 as the gripping surface 120 is rotated a progressively greater force is applied to the tarp 68 as the tarp 68 is forced against the platform 70 by the gripping surface 120. As such, the gripping surface 120 and slot 65 are configured to retain the material 68.

As previously described in relation to the tie down tension assembly configuration, as a tension is applied to the second line end 104 to overcome the bias placed on the cam 75 a tension is applied to the convertible tension assembly 5, any material 68 placed within the slot 65, and the first line end 102 of the line 100. Upon release of the tension on the second line end 104 the line 100 is held in place by the cam 75 to maintain tension on the convertible tension assembly 5, the material 68, and the first line end 102. In this manner, the conversion tension assembly 5 functions as a tarp grip tension assembly. Tension applied to the cam 75 to overcome the bias of the spring 95 allows the line 100 to move freely between the cam 75 and spacer 85 thereby removing the tension from the convertible tension assembly 5, the material 68, and first line end 102.

A method of converting a tension assembly described herein comprises rotating a rotatable device of the convertible tension assembly from an extended position to a retracted position, wherein the rotatable device includes an attachment device configured to extending from the tension assembly and attach to an anchor point to convert the tension assembly to a tie down tension assembly, and wherein the rotatable device includes a gripping surface, the tension assembly includes a slot configured to accept a tarp, and the slot and gripping surface retain the tarp to convert the tension assembly to a tarp grip tension assembly in the retracted position.

As described herein, the convertible tension assembly 5 includes a rotatable device 55 that converts the tension assembly from a tie tension assembly (FIG. 5A) to a tarp grip tension assembly (FIG. 5B). The multi-purpose functionality of the rotatable device 55 adds versatility and improves upon known tension assemblies. At least in one embodiment, the rotatable device 55 includes a hook 105, however other apparatus are adaptable including a hoop or circular attachment device, carbineer, or clip to serve a similar capacity to anchor or secure an object. If it is desired to secure, restrain, or hold a tarp or other material such as those used to cover an object, rotation of the rotatable device 55 easily and conveniently converts the tie down assembly to a tarp grip tension assembly.

As such, the subject matter disclosed herein provides for a convertible tension assembly having, among other things, a rotatable device configured and positioned to convert the tension assembly from tie down tension assembly to a tarp grip tension assemble resulting in an efficient, versatile, and simple to use convertible tension assembly to secure an object.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A convertible tension assembly comprising:
a rotatable device configured to rotate from an extended position to a retracted position,
wherein the convertible tension assembly converts to a tie down tension assembly with the rotatable device extended, and the convertible tension assembly converts to a tarp grip tension assembly with the rotatable device in the retracted position.

2. The convertible tension assembly of claim 1, further comprising:
a body having a first side and a second side spaced apart from each other to form a cavity between the first side and the second side, the first side and the second side joined together at a first end and a second end opposite the first end.

3. The convertible tension assembly of claim 2, wherein the rotatable device is positioned at the first end, extends from the body in the extended position and is disposed within the cavity formed between the first side and the second side in the retracted position.

4. The convertible tension assembly of claim 2, wherein the rotatable device includes a first device end and a second device end,
wherein the first device end includes an attachment device configured to attach to an anchor point, the attachment device extending from the body in the extended position, and the second device end includes a gripping surface and a slot formed in the first end of the body between the first side and the second side,
wherein the slot is configured to accept a tarp, and in the retracted position the gripping surface and slot retain the tarp.

5. The convertible tension assembly of claim 4, wherein the attachment device is a hook.

6. The convertible tension assembly of claim 4, wherein the slot includes a platform formed on a lower portion and extends into the body between the first side and second side;
wherein the gripping surface includes a generally curved surface and ribs formed on the curved surface, and
wherein as the rotatable device is rotated from the extended position to the retracted position the gripping surface exerts a progressively greater force on the material within the slot.

7. The convertible tension assembly of claim 4, further comprising a spring and a cam positioned at the second end of the body and connected between the first side and the second side, the cam biased by the spring to retain a line movable between the first side and the second side of the body.

8. A convertible tension assembly comprising:
a body having a first side and a second side spaced apart from each and joined together at a first end and a second end opposite the first end; and
a rotatable device configured to rotate from an extended position to a retracted position,
wherein the rotatable device is positioned at the first end and includes a first device end and a second device end;
wherein the first device end includes an attachment device configured to attach to an anchor point, the attachment device extending from the body in the extended position, and the second device end includes a gripping surface and a slot formed in the first end of the body between the first side and the second side, and
wherein the slot is configured to accept a tarp, and in the retracted position the gripping surface and slot retain the tarp.

9. The convertible tension assembly of claim 8, further comprising a cavity formed between the first side and the second side, the retractable device is disposed within the cavity formed between the first side and the second side in the retracted position.

10. The convertible tension assembly of claim 8, wherein the attachment device is a hook.

11. The convertible tension assembly of claim 8, wherein the slot includes a platform formed on a lower portion and extends into the body between the first side and second side;
wherein the gripping surface includes a generally curved surface and ribs formed on the curved surface, and
wherein as the rotatable device is rotated from the extended position to the retracted position the gripping surface exerts a progressively greater force on the material within the slot.

12. The convertible tension assembly of claim 8, further comprising a spring and a cam positioned at the second end of the body and connected between the first side and the second side, the cam biased by the spring to retain a line movable between the first side and the second side of the body.

13. A method of converting a tension assembly comprising;
rotating a rotatable device of the convertible tension assembly from an extended position to a retracted position,
wherein the rotatable device includes an attachment device configured to extending from the tension assembly and attach to an anchor point to convert the tension assembly to a tie down tension assembly, and
wherein the rotatable device includes a gripping surface, the tension assembly includes a slot configured to accept a tarp, and the slot and gripping surface retain the tarp to convert the tension assembly to a tarp grip tension assembly in the retracted position.

14. The method of claim 13, wherein the attachment device is a hook.
